(19) United States
(12) Patent Application Publication
(10) Pub. No.: US 2010/0162888 A1
(43) Pub. Date: Jul. 1, 2010

(54) MAT-SHAPED FOAM MATERIAL FOR CLEANING AND/OR FILTERING AIR

(76) Inventors: Hasso von Blücher, Erkrath (DE); Kami Klaus Kahrom, Erzhausen (DE)

Correspondence Address: Brannon & Associates PC, 1 North Pennsylvania Street, Suite 520, Indianapolis, IN, 46204, US

(21) Appl. No.: 12/663,706

(22) PCT Filed: Apr. 8, 2008
(86) PCT No.: PCT/EP08/02773

§ 371 Date: Dec. 8, 2009

(30) Foreign Application Priority Data
Jun. 8, 2007 (DE) 10-2007-027.026.9

(51) Int. Cl. B01D 53/02

(52) U.S. Cl. 95/90; 96/135

(57) ABSTRACT

The invention relates to a matlike foam material stock which is suitable more particularly for purposes of air purification and/or air filtration and can be used preferably for installation in ceilings and ceiling systems, walls and wall systems, air-conditioning devices, ventilation shafts, as building material or the like. The matlike foam material stock comprises a gas-permeable, more particularly air-permeable, matlike three-dimensional support, the support being formed as an open-cell or open-pore foam, more particularly foam material, and an odorant- and/or noxiant-sorbing material being taken up or provided in the support, the odorant- and/or noxiant-sorbing material being designed as an odorant- and/or noxiant-sorbing, more particularly odorant- and/or noxiant-adsorbing, sorbent based on discrete sorptive particles, the sorptive particles being fixed on the support, more particularly on the walls of the cells or pores of the foam, more particularly foam material.

### CROSS-REFERENCES TO RELATED APPLICATIONS

This application is a National Stage filing of International Application PCT/EP2008/002773, filed Apr. 8, 2008, claiming priority to German Application No. DE 10 2007 027 026.9 filed Jun. 8, 2007, entitled “Mat-shaped Foam Material for Cleaning and/or Filtering Air”. The subject application claims priority to PCT/EP2008/002773 and to German Application No. DE 10 2007 027 026.9 and incorporates all by reference herein, in their entirety.

### BACKGROUND OF THE INVENTION

The present invention relates to the field of air purification and/or air filtration. More particularly the present invention relates to matlike foam material stocks having adsorptive properties and also to their use. The present invention relates more particularly to a matlike foam material stock in accordance with the precharacterizing clause of claim 1, and to its use.

For the reason first of an increasing environmental awareness but also, second, as a consequence of highly sensitive methods of analysis, the exposure to noxiants and odorants of our ambient and wider environment is moving ever more into the public arena. For example, for the sector of buildings exposed to noxiants and/or odorants, there is an increased demand for these buildings to be freed from noxiants and/or odorants, and remediated where necessary, with the least possible cost and inconvenience. Moreover, a demand exists to make corresponding improvements to the ambient air conditions or room air in areas exposed to noxiants and/or odorants.

Noxiants in the context of the present invention is the term used more particularly for those substances which even in small amounts may trigger irritation, allergies or diseases in humans. They include, for example, wood preservatives, such as pentachlorophenol (PCP) and lindane, plasticizers, such as polychlorinated biphenyls (PCBs), the so-called VOCs, and formaldehyde as well. Formaldehyde, for example, has been used in chipboard and is now classed as carcinogenic. Hydrocarbons as well, whether aromatic or not, and their chlorinated derivatives, as noxiants in the sense of the present invention, may also escape from varnishes, paints, adhesives or the like for example.

As mentioned above, volatile organic substances, commonly referred to as VOCs (volatile organic compounds), are also among the noxiants in the sense of the present invention that may to a greater or lesser extent affect the ambient air conditions or ambient air. In accordance with the World Health Organization definition, VOCs are organic substances having a boiling range in general of 60 to 250° C.; the VOCs include, for example, compounds from the classes of the alkanes and alkenes, aromatics, terpenes, halogenated hydrocarbons, esters, aldehydes, and ketones. There are a multiplicity of naturally occurring VOCs, some of them also emitted in considerable quantities into the atmosphere, such as, for example, terpenes and isoprenes from forests. The environmental VOC burden caused by human activities, however, has risen sharply over the last century. The largest contributor to this is traffic, but immediately behind it in second place is the construction sector, with the chemical products it uses, such as paints, adhesives, sealants or the like, for example. As well as the building materials, possible sources of VOCs in interiors include furnishings, cleaning and care products, craft and DIY products, office chemicals, tobacco smoke, rugs and carpets, etc. The hazard potential from this group of substances is very varied, since the substances involved are a multiplicity of very different substances which, accordingly, can also have very different effects on health. The following statements, though, can be used to circumscribe the VOC problem: the VOCs include a number of compounds which are classed as highly toxic or even as carcinogenic, such as benzene, for example. Responsibility also for typical symptoms of so-called “sick building syndrome”, such as dry mucous membranes of the eyes, nose and throat, is placed at the door of VOCs. Furthermore, runny noses, weeping eyes, itching, tiredness, headaches, restricted intellectual capacity, increased susceptibility to infection, and unpleasant odors and taste sensations are observed in connection with increased VOC exposure.

Among particularly problematic noxiants are the aforementioned PCBs, which have been used, for example, as plasticizers in joint-sealing compounds, particularly in the erection of buildings from prefabricated elements. More recent findings have shown that, over the course of time, PCBs may diffuse from sealants into the adjacent concrete elements and may also be emitted from the joint seals into the ambient air. As a result of air exchange, the PCB-laden air is then distributed throughout the building. Some of the PCB released in this way from the joint seals is deposited in particle-bound form in the rooms, but a large proportion also dissolves in paints and plastics, leading to the formation, after some time of release, of a series of what are called secondary emission sources, including, in particular, painted wall and ceiling areas. These secondary sources then comprise in general an amount of PCBs which is such that they constitute a large surface area for emissions, meaning that the removal of the joint seals alone may not result in a drop in PCB concentrations below the prescribed levels in the ambient air.

As already mentioned, a further source of noxiants and/or odorants may be constituted, for example, by rugs and carpets. The emissions come about, for example, by starting materials in these products reacting under the action of moisture and/or under the influence of constituents of the substrate materials, with the consequence that, even after the removal of the floor covering, the floor continues to emit odorants and/or noxiants, and so either the entire floor must be removed or else an intermediate floor with back-ventilation must be laid.

Another source of unpleasant and in some cases also unhealthy emissions is made up of additions to the building material itself. For example, many buildings are affected by vaporous emission of ammonia, which can be traced back to the use of ammonium salts, ureas or organic amines in the widest sense as antifreeze agents for concrete and mortar. Furthermore, the prior use of a room (for keeping animals, for example) is also occasionally cited as a cause of the vaporous emission of amines, and means that construction elements become charged over a relatively long time period with the noxiants from the air. Even in the case of the removal of the primary emission sources of these substances, as in the case, for instance, of conversion of a stable building to a living or business space, these noxiants and/or odorants then continue to be emitted from the secondary sources, namely wall and ceiling areas.

And again, odors which are relatively harmless, in the sense that they are not necessarily a hazard to health, may occasionally burden the ambient air conditions, examples being the odorants and unpleasant odors that come from garbage containers, toilets, drains or the like.

In the prior art there has been no lack of attempts to remove the noxiants and odorants of the type described above. In the majority of cases the methods known from the prior art for this purpose lack performance or are not very efficient, or else provide only an incomplete solution to the problem they address. Many methods and materials employed for them, moreover, are not universal in respect of their spectrum of application, and more particularly can usually be used only for a very specific purpose.

Thus DE 40 28 434 A1 provides a possible means of removing PCB-emitting noxiant sources in the form of PCB-laden joint-sealing compounds in which suitable measures are taken to excise the sealant, i.e., only the primary source, and dispose of it. Consequently, however, the process acts only on the primary sources, thus leaving decontamination of the secondary sources unregarded.

Moreover, DE 38 18 993 A1 discloses a process for remediating noxiant-exposed rooms, in which the noxiant-exposed room air is purified by taking suitable measures to pass air over adsorbents artificially or simply by inherent circulation. For example, the noxiant-exposed air is pressed through adsorption towers that are charged with adsorbents. Another possibility described therein involves passing the air in front of sheetlike structures of large surface area—such as curtains, for example—that are loaded with adsorbents. This process has the key disadvantage of acting only on the room air that has already been exposed, and which always mixes again with the noxiant-exposed air, with the consequence that, at best, a dilution effect is achieved.

In addition there are planar textile materials known that are charged with adsorbents, generally provided with a coating which is impervious to water but permeable to water vapor, these materials, depending on the noxiant source, being constructed in the form of wall coverings, floor coverings or the like, and being applied over the corresponding sources emitting noxiants and/or odorants (cf., e.g., DE 44 32 834 A1, DE 44 47 844 C2, DE 196 07 423 A1 and DE 200 08 162 U1). The materials described therein, however, are not suitable as wall, floor or ceiling elements. Furthermore, WO 2005/026465 A2 discloses construction materials for interior fitting, based on gypsum construction boards, such as gypsum plasterboard and gypsum fiberboard, for example, which contain zeolites in amounts from 1% to 25% by weight and are intended to reduce airborne noxiants in interiors, such as formaldehydes, ammonia, tobacco smoke, etc. The zeolites used therein, however, do not always yield the desired result, not least on account of their sometimes inadequate capacity to degrade or sorb noxiants and/or odorants from the ambient air. Since, in the production of the gypsum boards, the zeolites are incorporated into the gypsum component with stirring, a large part of their surface area, moreover, is not freely available to the noxiants and odorants that are to be taken up and/or decomposed, with the consequence that the noxiants and odorants have to diffuse through the gypsum compound to the zeolites installed therein. For the reasons given above, relatively large quantities of zeolites must be used, and this may adversely affect the building materials themselves, especially with regard to their cohesion or their stability.

### BRIEF SUMMARY OF INVENTION

The problem addressed by the present invention lies therefore, in particular, in the provision of materials which can be used universally as far as possible and have adsorptive properties with regard to odorants and/or noxiants, and which at least largely avoid the above-depicted disadvantages of the prior art, or else are intended at least to attenuate these disadvantages.

The aim in particular is to provide materials based more particularly on matlike foam (material) stocks having adsorptive properties, the materials being intended to enable—as far as possible—universal and/or efficient usefulness with regard to a reduction in levels of odorants and/or noxiants from the ambient air.

The applicant has now surprisingly discovered that the problem outlined above can be solved by embodying a matlike foam material stock which is suitable in particular for air purification and/or air filtration purposes, preferably for installation into ceiling and ceiling systems, walls and wall systems, air-conditioning devices, ventilation shafts, as building material or the like, in such a way that the foam material stock comprises a gas-permeable, more particularly air-permeable, matlike three-dimensional support, the support being formed as an open-cell or open-pore foam, more particularly foam material, and in such a way that an odorant- and/or noxiant-sorbing material is taken up or provided in the support, the odorant- and/or noxiant-sorbing material being formed as an odorant- and/or noxiant-sorbing, more particularly odorant- and/or noxiant-adsorbing, sorbent based on discrete sorptive particles, the sorptive particles being fixed on the support, more particularly on the walls of the cells or pores of the foam, more particularly foam material.

To solve the problem outlined above, therefore, the present invention proposes, in accordance with a first aspect of the present invention, a foam (material) stock, more particularly a matlike foam (material) stock 1, which includes a gas-permeable, more particularly air-permeable matlike three-dimensional support 2 formed as an open-cell or open-pore foam, more particularly a foam material. An odorant- and/or noxiant-sorbing material 3 is taken up into support 2. The odorant- and/or noxiant-sorbing material 3 is formed as an odorant- and/or noxiant sorbing, more particularly odorant- and/or noxiant-adsorbing sorbent based on discrete sorptive particles.

The sorptive particles are fixed on the support 2, more particularly on the walls of the cells or pores 4 of the foam, more particularly foam material. The sorptive particles 3 are formed of activated carbon having an average particle diameter in the range of from 0.01 to 2.0 mm and are fixed within a support containing pores wherein: (a) at least 60% of the pores have pore diameters of ≦20 Å and (b) the ratio of average pore diameter of the open-cell or open-pore foam material utilized for the support to the average particle diameter of the sorptive particles is in the range of from 1.5 to 7. Further, advantageous embodiments are subject matter of the appendant subclaims (claims 2 to 18).

Furthermore, a second aspect of the present invention involves a process for eliminating emissions of noxiants or oderants by means of adsorption utilizing the matlike foam material described above. Advantageous embodiments of the process are the subject matter of the dependent (claims 18 to 21).

### BRIEF DESCRIPTION OF THE DRAWINGS

FIG. 1A shows a schematic section through a foam material stock of the invention in accordance with one embodiment of the present invention.

FIG. 1B shows an enlarged section through the layer construction of the foam material stock of the invention as per FIG. 1A.

### DETAILED DESCRIPTION OF INVENTION

The present invention accordingly provides—in accordance with a first aspect of the present invention—a matlike foam material stock which is suitable in particular for air purification and/or air filtration purposes, preferably for installation into ceilings and ceiling systems, walls and wall systems, air-conditioning devices, ventilation shafts, as building material or the like, where the foam material stock comprises a gas-permeable, more particularly air-permeable, three-dimensional support, the support being formed as an open-cell or open-pore foam, more particularly foam material, and where provided and/or taken up in the support there is an odorant- and/or noxiant-sorbing material, the odorant- and/or noxiant-sorbing material being formed as an odorant- and/or noxiant-sorbing, more particularly odorant- and/or noxiant-adsorbing, sorbent based on concrete sorptive particles, the sorptive particles being fixed on the support, more particularly on the walls of the cells or pores of the foam, more particularly foam material.

As described above, a characteristic of the present invention is that a support structure based on a foam which is laden with the sorptive particles is used. In the context of the present invention, the concept of foam refers more particularly to a structure made up, in the state in which it is used, of gas-filled or air-filled, spherical or polyhedral cells which are bounded and separated from one another by solid cell struts. The cell struts, which themselves are connected via nodal points, form a coherent framework. Foam lamellae may extend between the cell struts, and in the case of open-cell or open-pore foams are at least partly destroyed. For further details regarding the concept of foam, reference may be made, for example, to Römpp Chemielexikon, 10th Edition, Georg Thieme Verlag, Stuttgart/New York, entry heading “Schaum”, and also the references cited therein, the entire disclosure content of the aforementioned references being hereby incorporated by reference.

In the context of the present invention, the support used is an open-cell or open-pore foam or foam material.

In accordance with the invention, the concept of foam material refers more particularly to materials of construction having cells or pores distributed over their entire mass, these cells or pores being open in the case of the present invention, and having an apparent density which is lower than that of the framework or foam substance. Generally speaking, organic polymers (e.g., foam plastics) function as the framework substance.

These foam materials can be subdivided in accordance with DIN 7726 (May 1982) into rigid foam materials, semirigid foam materials, flexible foam materials, elastic foam materials, and elastomeric foam materials, as a function of their deformation resistance under a compressive load: elastic foam materials are those which on pressure deformation to DIN 53580 of up to 50% of their thickness do not exhibit a permanent deformation of more than 2% of their original volume, whereas rigid foam materials to DIN 7726 (May 1982) are foam materials which, on deformation under compressive load, present a relatively high resistance (compressive stress at 10% deformation or compressive strength according to DIN 53421, June 1984, ≦80 kPa).

Further divisions of the foams are made in accordance inter alia with the framework substance (e.g., polyurethane foams, polystyrene foams, polyolefin foams, polyvinyl chloride foams, etc.), the class of material of construction of the framework substance (e.g., elastomeric foam materials, thermoelastomeric foam materials, thermoplastic foam materials, etc.), the type, size, and shape of the foam material cells (e.g., open-cell foam materials, mixed-cell foam materials, coarse- and fine-cell foam materials, spherical foam materials, honeycomb foam materials, double-layer or true foam materials, single-layer or false foam materials, etc.), according to density (e.g., lightweight foam materials with densities≦100 kg/m³, and heavy foam materials with densities≧100 kg/m³) or density distribution (e.g., structured foam materials or integral foam materials, etc.).

For further details regarding the concept of foam material, reference may be made, for example, to Römpp Chemielexikon, 10th Edition, Georg Thieme Verlag, Stuttgart/New York, entry headings: “Schaumstoffe”, “Hartschaumstoffe”, “Weichschaumstoffe”, “Integralschaumstoffe” and “Schaum”, and also to the references cited in each of those entries, the entire disclosure content of the aforementioned references being hereby included by reference.

In accordance with one inventively preferred embodiment the support used is an open-pore and/or an open-cell foam, more particularly foam material, based on at least one organic polymer, more particularly based on polyurethanes, polyolefins, polystyrenes, polyvinyl chlorides, polyisocyanurates, and formaldehyde resins, more preferably a polyurethane foam material. Inventively preferred is an open-pore and/or an open-cell foam, more particularly foam material, having an average pore diameter of 1 to 5 mm, preferably 1.5 to 3 mm (so-called large-pore or coarse-cell foam or foam material), since in this way not only high air permeability and hence a high filtration throughput but also good loadability or loading capacity with the sorptive particles are achieved. Inventively preferred is an open-pore and/or open-cell foam, more particularly foam material, having a density ≦100 kg/m³.

In accordance with one inventively more preferred embodiment, the support is an open-pore and/or open-cell foam material based on polyurethane or on polyolefin (i.e. an open-pore and/or open-cell PU foam material or PO-based), more particularly a preferably large-pore reticulated polyurethane foam material (preferably having a pore diameter of 1 to 5 mm, preferably 1.5 to 3 mm) and/or preferably having a density 100 kg/m³.

In accordance with one inventively preferred embodiment, the support, more particularly foam or foam material, has a poriness (porosity) of 5 to 50 ppi (pores per inch) more particularly 10 to 30 ppi.

In the context of the present invention the support, more particularly foam or foam material, is typically of planar formation. Generally speaking, the support, more particularly foam or foam material, has a thickness of 1 to 40 mm, more particularly 5 to 30 mm, preferably 10 to 25 mm.

Advantageously the support is of self-supporting formation. Generally speaking, materials are used of a kind that result in the support being of thermally stable formation, more particularly up to at least 80° C., preferably up to at least 100° C., more preferably up to at least 120° C.

In accordance with one inventively more preferred embodiment, the support, more particularly foam or foam material, is stiffened and/or cured, preferably by—in particular—thermal and/or chemical curing. Alternatively it is also possible for a rigid foam material within the meaning of DIN 7726 (May 1982) to be employed.

In accordance with one inventively more preferred embodiment, the support, more particularly foam or foam material, is for this purpose first impregnated with a chemical curing agent and subsequently cured, the curing agent being able to be, for example, an adhesive (e.g. a chemically curing or chemically crosslinking adhesive) or another kind of curing agent, the curing agent in this case being able to serve equally for the fixing of the sorptive particles on the support. As a result of the curing, the foam or foam material, relative to its original state, is not, or is at least substantially no longer, reversibly deformable.

Typically the sorptive particles are fixed on the support by means of a bonding composition, more particularly by means of an adhesive. As described above, it is possible advantageously for the bonding composition or the adhesive for the fixing of the sorptive particles to the support to be at the same time the curing agent for the support.

As far as the quantitative loading of odorant- and/or noxiant-sorbing material is concerned, this quantitative loading is typically designed such that the sorption capacity, more particularly adsorption capacity, provided by the odorant- and/or noxiant-sorbing material is sufficient when the foam material stock of the invention is used to effect long-term adsorptive binding and/or removal of emissions of noxiants and/or odorants from the ambient environment.

Generally speaking, the matlike foam material stock of the invention may contain the odorant- and/or noxiant-sorbing material in wide quantitative ranges. Typically the foam material stock of the invention contains the odorant- and/or noxiant-sorbing material in amounts of 30% to 90% by weight, more particularly 40% to 85% by weight, preferably 50% to 80% by weight, more preferably 55% to 80% by weight, based on the foam material stock; this results in a very high adsorption capacity and in an efficient performance capacity of the foam material stock of the invention. Nevertheless, for certain applications or in certain specific cases, it may be necessary to depart from the aforementioned values, without departing from the scope of the present invention.

The foam material stock according to the present invention has generally a total basis weight of 1500 to 8000 g/m², more particularly 2000 to 6000 g/m², preferably 2500 to 5000 g/m².

In spite of the high density of loading with odorant- and/or noxiant-sorbing material, the foam material stock of the invention has a high air permeability, expressed below in terms of pressure loss, and this is beneficial to the efficiency in relation to air purification and/or air filtration. Typically the foam material stock according to the present invention exhibits a pressure drop, more particularly determined in accordance with DIN ISO 11155-1,
of not more than 15 Pa, more particularly 10 Pa, preferably not more than 5 Pa, for an inflow velocity of 0.35 m/s and/or
of not more than 30 Pa, more particularly 25 Pa, preferably not more than 15 Pa, for an inflow velocity of 0.7 m/s and/or
of not more than 50 Pa, more particularly 40 Pa, preferably not more than 25 Pa, for an inflow velocity of 1 m/s and/or
of not more than 100 Pa, more particularly 80 Pa, preferably not more than 50 Pa, for an inflow velocity of 1.5 m/s.

The sorption performance as well, more particularly adsorption performance, of the foam material stock of the invention is excellent. Thus the foam material stock of the invention is characterized by the following sorption performance, more particularly adsorption performance, in respect of toluene, when charged with an air stream containing 10 ppm toluene at 23° C., at 50% relative humidity, and at 0.35 m/s inflow velocity, determined more particularly in accordance with DIN ISO 11155-2:
Initial breakthrough: <5%, more particularly <2%, preferably <1%, and/or
Time to a breakthrough of 10%: >10 h, more particularly >15 h, preferably >20 h, and/or
Time to a breakdown of 50%: >15 h, more particularly >18 h, preferably >25 h.

Furthermore, the foam material stock of the invention is characterized by the following sorption performance, more particularly adsorption performance, in relation to toluene, measured on an air flow containing 10 ppm toluene at 23° C., at 50% relative humidity, and at 0.73 m/s inflow velocity, determined more particularly in accordance, with DIN ISO 11155-2:
Initial breakthrough: <10%, more particularly <5%, preferably <2%, and/or
Time to a breakthrough of 10%: >1 h, more particularly >5 h, preferably >10 h, and/or
Time to a breakdown of 50%: >5 h, more particularly >10 h, preferably >17 h.

Generally speaking, sorptive particles used are porous sorptive particles, i.e., sorptive particles which have pores for taking up and/or storing, more particularly adsorbing, odorants and/or noxiants, i.e., in other words, the sorptive particles used in accordance with the invention have a porous structure which enables them to take up or store, more particularly to adsorb, odorants and/or noxiants.

As described above, the odorant- and/or noxiant-sorbing material which is used in accordance with the present invention is particulate, more particular granular, preferably spherical, in construction.

The granularly, more particularly spherically, constructed sorptive particles in this case more particularly have average particle diameters in the range from 0.01 to 2.0 mm, more particularly 0.05 to 1.0 mm, preferably 0.1 to 0.8 mm.

As the applicant has surprisingly discovered, important factors with respect to good adsorption performance, more particularly adsorption efficiency and adsorption kinetics, and a good breakthrough behavior are not only the pore diameter of the open-pore or open-cell foam or foam material used as support, and the particle diameter of the sorptive particles, but also their ratio to one another. Surprisingly, particularly good adsorption performance, particularly adsorption efficiency and adsorption kinetics, and a particularly good breakthrough behavior are obtained especially when the ratio of average pore diameter of the open-pore or open-cell foam or foam material used as support to average particle diameter of the sorptive particles is at least 1.2, more particularly at least 1.5, preferably at least 1.7, more preferably at least 2; generally speaking, this ratio is in the range from 1.2 to 7, more particularly 1.5 to 6, preferably 1.7 to 5, more preferably 2 to 4.

The sorbent may be selected more particularly from the group consisting of active carbon; zeolites; inorganic oxides, more particularly zeolites, silica gels, and aluminum oxides; molecular sieves, mineral granules; clathrates; and also mixtures thereof.

The noxiant- and/or odorant-adsorbing material used with preference in accordance with the invention is activated carbon, i.e. the odorant- and/or noxiant-sorbing material or the sorbent is formed advantageously on the basis of activated carbon.

As described above, in accordance with one preferred embodiment of the present invention, the odorant- and/or noxiant-sorbing material used in accordance with the invention is particulate, more particularly granular, preferably spherical, in formation. Nevertheless, other forms as well, such as fibers, for example, such as activated carbon fibers, or powderous activated carbon, etc., are contemplated.

It is preferred in accordance with the invention, however, if the odorant- and/or noxiant-sorbing material is in the form of granular, preferably spherical, activated carbon particles, i.e., the activated carbon is of granular formation (“granulocarbon”), preferably of spherical formation (“spherocarbon”). In this case the activated carbon grains, preferably activated carbon spheres, advantageously have average particle diameters in the range from 0.01 to 2.0 mm, more particularly 0.05 to 1.0 mm, preferably 0.1 to 0.8 mm.

Activated carbon grains, preferably activated carbon spheres, used with preference in accordance with the invention have a bursting pressure of at least 5 newtons, more particularly a bursting pressure in the range from 5 newtons to 20 newtons, per activated carbon grain or activated carbon sphere.

In order to ensure high performance capacity on the part of the foam material stock of the invention it is advantageous if the odorant- and/or noxiant-sorbing material used, more particularly the activated carbon used, has a specific surface area (BET) of at least 500 m²/g, more particularly at least 750 m²/g, preferably at least 1000 m²/g, more preferably at least 1200 m²/g. Generally speaking, the odorant- and/or noxiant-sorbing material used in accordance with the invention, more particularly the activated carbon used in accordance with the invention, has a specific surface area (BET) in the range from 500 to 2500 m²/g, more particularly 750 to 2250 m²/g, preferably 900 to 2000 m²/g, more preferably 1000 to 1750 m²/g. In relation to the BET method, reference may be made, for example, to Römpp Chemielexikon, 10th Edition, Georg Thieme Verlag, Stuttgart/New York, entry heading: “BET-Methode”, and also to the references cited therein, more particularly Winnacker-Küchler, 3rd Edition, Volume 7, pages 93 ff., and also Z. Annal. Chem. 238, pages 187 to 193 (1968).

In order to allow high efficiency on the part of the foam material stock of the invention, it is preferred for the odorant- and/or noxiant-sorbing material used, more particularly the activated carbon used, to be an activated carbon having an adsorption volume V_{ads} of at least 250 cm³/g, more particularly at least 300 cm³/g, preferably at least 350 cm³/g, more preferably at least 400 cm³/g. Generally speaking, an activated carbon having an adsorption volume V_{ads} of 250 to 1000 cm³/g, more particularly 300 to 900 cm³/g, preferably 350 to 750 cm³/g, is used.

Preferred in accordance with the invention is an activated carbon having a total pore volume by the Gurvich method of at least 0.50 cm³/g, more particularly at least 0.55 cm³/g, preferably at least 0.60 cm³/g, more preferably at least 0.65 cm³/g, very preferably at least 0.70 cm³/g. Generally speaking, an activated carbon having a total pore volume by the Gurvich method of 0.50 to 0.90 cm³/g, more particularly 0.55 to 0.85 cm³/g, preferably 0.60 to 0.80 cm³/g, more preferably 0.65 to 0.80 cm³/g, very preferably 0.70 to 0.75 cm³/g, is used. For further details regarding the determination of the total pore volume by the Gurvich method, reference may be made, for example, to L. Gurvich (1915), J. Phys. Chem. Soc. Russ. 47, 805, and also to S. Lowell et al., Characterization of Porous Solids and Powders: Surface Area Pore Size and Density, Kluwer Academic Publishers, Article Technology Series, pages 111 ff.

The applicant has discovered that a particularly suitable activated carbon is an activated carbon having a large micropore volume fraction, based on the total pore volume of the activated carbon. In the context of the present invention the concept of micropore volume refers more particularly to the pore volume of the activated carbon that is provided by pores having a diameter of ≦25 Å (2.5 nm), more particularly ≦20 Å (2.0 nm).

The reason is that the applicant has surprisingly discovered that the reduction of the concentrations of noxiants and/or odorants is particularly efficient when the micropore volume fraction of the activated carbon used is particularly high. Without wishing to be tied to any particular theory, the particularly high efficiency with an activated carbon having a particularly large micropore volume fraction may be attributed to the fact that the micropores, on account of their small size, are able to interact, so to speak, from all sides or walls with the molecules to be sorbed or adsorbed. Use is made more particularly of an activated carbon having a fraction of the micropore volume, based on the total pore volume of the activated carbon, of at least 60%, more particularly at least 65%, preferably at least 70%.

Use is made more particularly, in an inventively preferred way, of an activated carbon having a micropore volume fraction, formed of pores having pore diameters of ≦25 Å, preferably ≦20 Å, of at least 60%, more particularly at least 65%, preferably at least 70%, based on the total pore volume of the activated carbon.

An activated carbon used with preference in accordance with the invention has a micropore volume, i.e., a micropore volume formed of pores having pore diameters of ≦25 Å, preferably ≦20 Å, by the carbon black method of at least 0.40 cm³/g, more particularly at least 0.45 cm³/g, preferably at least 0.50 cm³/g. Generally speaking, this micropore volume by the carbon black method is in the range from 0.40 to 0.80 cm³/g, more particularly 0.45 to 0.75 cm³/g, preferably 0.50 to 0.60 cm³/g.

For further details of the determination of the pore surface area by the carbon black method, reference may be made, for example, to R. W. Magee, Evaluation of the External Surface Area of Carbon Black by Nitrogene Adsorption, Presented at the Meeting of the Rubber Division of the American Chem. Soc., October 1994, referred to, for example, in: Quantachrome Instruments, AUTOSORB-1, AS1 WinVersion 1.50, Operating Manual, P/N 05061, Quantachrome Instruments 2004, Florida, USA, pages 71 ff.

On the basis of the high microporosity of the activated carbon used with preference in accordance with the invention, it equally has a high specific micropore surface area fraction. The specific micropore surface area fraction, i.e. the surface area fraction accounted for by pores having pore diameters of ≦25 Å, preferably ≦20 Å, is at least 70%, more particularly at least 75%, preferably at least 80%, very preferably at least 85%, based on the specific total surface area (BET) of the activated carbon. More particularly this micropore surface area fraction is in the range from 70% to 95%, more particularly 75% to 95%, preferably 80% to 90%.

On the basis of its microporosity, the activated carbon used with preference in accordance with the invention equally has a large micropore surface area. More particularly the micropore surface area by the carbon black method (i.e. the micropore surface area formed of pores having pore diameters of ≦25 Å, preferably ≦20 Å) is at least 400 m²/g, more particularly at least 800 m²/g, preferably at least 1000 m²/g, more preferably at least 1200 m²/g. In accordance with one preferred embodiment this micropore surface area is in the range from 400 to 1750 m²/g, more particularly 800 to 1500 m²/g, preferably 1000 to 1400 m²/g, more preferably 1100 to 1300 m²/g.

Preference in accordance with the invention is given to using, as the activated carbon, a microporous activated carbon having an average pore diameter (mean pore diameter) of not more than 35 Å, preferably not more than 30 Å, more preferably not more than 25 Å. More particularly this average pore diameter is in the range from 15 to 35 Å, more particularly 15 to 30 Å, preferably 15 to 25 Å.

As far as the density of the activated carbon used with preference in accordance with the invention is concerned, the apparent density of the activated carbon used is generally in the range from 700 to 975 g/cm³, more particularly 750 to 950 g/cm³, preferably 800 to 900 g/cm³. The bulk density of the activated carbon used, on the other hand, is in the range from 300 to 900 g/cm³, more particularly 350 to 800 g/cm³, preferably 400 to 750 g/cm³.

For particularly good efficiency it is of advantage if the activated carbon used has a total porosity of 40% to 70%, more particularly 45% to 65%, preferably 50% to 60%.

Inventively preferred is the use as activated carbon of an activated carbon having a specific total pore volume in the range from 0.1 to 2.5 cm³/g, more particularly 0.2 to 2.0 cm³/g, preferably 0.3 to 1.5 cm³/g, more preferably 0.4 to 1.0 cm³/g. The fraction of pores having pore diameters of ≦36 Å in this case is at least 65%, more particularly at least 70%, preferably at least 75%, and can reach values of up to 95%, more particularly up to 90%.

A microporous activated carbon which is particularly suitable in accordance with the invention and which fulfills the aforementioned properties and specifications is sold for example by Blücher GmbH, Erkrath, Germany, or by AdsorTech GmbH, Premnitz, Germany.

In order to increase the adsorption performance, the activated carbon used in accordance with the invention may be provided with an impregnation. This is known per se to a person skilled in the art.

An impregnation of this kind may be selected, for example, from the group consisting of
(i) metals, preferably copper, silver, cadmium, platinum, palladium, rhodium, zinc, mercury, titanium, zirconium, molybdenum and/or aluminum, more particularly ions and/or salts thereof;
(ii) enzymes;
(iii) basic compounds, more particularly organic bases, such as organic amines;
(iv) acidic compounds, more particularly hydrochloric and sulfuric acid compounds or free organic or inorganic acids;
   and also mixtures of the aforementioned impregnations.

Where an activated carbon provided with an impregnation is used, the impregnation is applied in general in an amount, based on the activated carbon, of 0.01% to 30% by weight, preferably 0.1% to 20% by weight, more preferably 1% to 15% by weight, very preferably 1% to 10% by weight, to the activated carbon.

The aforementioned impregnation compounds permit in some cases the catalytic decomposition of certain odorants and/or noxiants and/or their accelerated degradation and/or their accelerated adsorption.

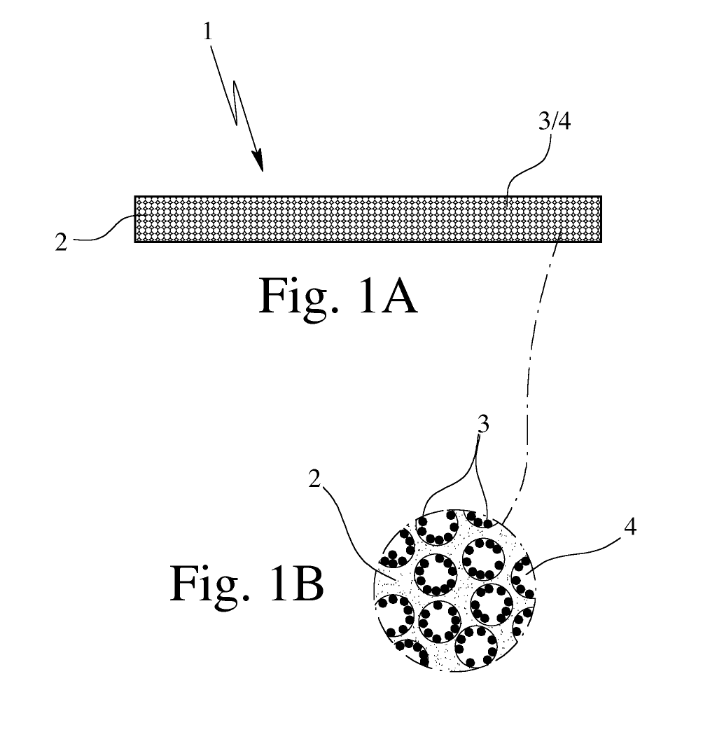

Further advantageous properties, aspects, and features of the present invention will become apparent from the following description of examples that are shown in the figures.
FIG. 1A shows a schematic section through a foam material stock of the invention in accordance with one embodiment of the present invention; and
FIG. 1B shows an enlarged section through the layer construction of the foam material stock of the invention as per FIG. 1A.

FIG. 1A shows a schematic section through a matlike foam material stock 1 of the invention, which is suitable in particular for air purification and/or air filtration purposes, preferably for installation into ceiling and ceiling systems, walls and wall systems, air-conditioning devices, ventilation shafts, as building material or the like.

As is apparent from the enlarged section of FIG. 1B, the matlike foam material stock 1 of the invention has a gas-permeable, more particularly air-permeable matlike three-dimensional support 2, the support 2 being formed as an open-cell or open-pore foam, more particularly foam material. Provided or taken up in the support 2 is an odorant- and/or noxiant-sorbing material 3, the odorant- and/or noxiant-sorbing material 3 being formed as an odorant- and/or noxiant-sorbing, more particularly odorant- and/or noxiant-adsorbing sorbent on the basis of concrete sorptive particles, the sorptive particles being fixed on the support 2, more particularly on the walls of the cells or pores 4 of the foam, more particularly foam material.

For further details regarding the embodiment shown in the figures, reference may be made to the above general information on the foam material stock of the invention, in accordance with the present invention, that information applying equally in relation to the embodiment shown in the figures.

Associated with the foam material stock of the invention are a multiplicity of advantages, which can be set out below on a merely indicative basis:

The foam material stock according to the present invention permits diverse, universal applicability in relation to eliminating emissions of noxiants and/or odorants, more particularly by means of adsorption. As outlined additionally below, the foam material stock according to the present invention can be employed almost arbitrarily for universal application possibilities, thus for example for eliminating emissions of noxiants and/or odorants in enclosed spaces, buildings, vehicles, etc.

As described above, the foam material stock of the invention provides a high adsorption capacity in relation to emissions of noxiants and odorants. With this material, following exhaustion of the adsorption capacity, regeneration may readily take place, by the total foam material stock being subjected to a thermal desorption treatment. In this way, following its use, the foam material stock according to the present invention can be readily recycled. However, the adsorption capacity provided by the foam material stock of the invention is in general large enough that exhaustion of the adsorption capacity is anticipated, if at all, at most only after a very long period of application.

As described above, the foam material stock of the invention allows universal application possibilities.

The present invention accordingly provides—in accordance with a second aspect of the present invention—the use of the above-described foam material stock of the invention for eliminating emissions of noxiants and/or odorants, more particularly by means of adsorption, more particularly in enclosed spaces, buildings, vehicles, etc.

Hence the foam material stock according to the present invention is suitable, for example, for removing noxiants and/or odorants in spaces exposed to noxiants and/or odorants.

Furthermore, the foam material stock according to the present invention is suitable for room air improvement and/or for improving room air conditions.

The elimination of the emissions of noxiants and/or odorants may take place for purposes of the mere removal of noxiants and/or odorants in rooms exposed to noxiants and/or odorants, for purposes of the remediation of rooms exposed to noxiants and/or odorants, or for purposes of room air improvement or for improving room air conditions. However, there may also be some architectural preservation, more particularly for the purpose of preventing the contamination of a built structure with noxiants and/or poisons that are emitted into the room air as well (e.g., in dry-cleaning units, chemical plants, laboratories, etc.).

By way of example the foam material stock of the invention may be used for room air purification and/or room air filtration, more particularly in rooms for semiconductor fabrication.

Furthermore, the matlike foam material stock according to the present invention may be employed for installation into ceiling systems, walls and wall systems, air-conditioning devices (e.g., air-conditioning systems), ventilation shafts, as building material or the like.

As described above, the matlike stock of the invention, on the basis of its universality and on the basis of its adsorption capacity, more particularly with regard to its adsorption efficiency, allows a wide spectrum of application. For example, the matlike foam material stock of the invention can be employed for air filtration in motor vehicle passenger compartments or in aircraft. The matlike foam material stock of the invention is also suitable, for example, for odorant and/or noxiant purification in buildings or in the context of environmental protection. As a consequence of the high level of loading with the sorptive particles, a high performance capacity of the foam material stock of the invention is provided. As a consequence of the high air permeability of the support, a high filtration efficiency is achieved. On the basis of its versatility, the matlike foam material stock according to the present invention can be employed in many shape configurations (round, angular, etc.), and thus permits universal installation.

Equally the foam material stock of the invention is also suitable for mobile filtration applications. Furthermore, it is equally suitable for fixed applications of the type described above.

Further embodiments, modifications, and variations of the present invention are readily apparent and realizable for the person skilled in the art, from reading the description, without said person departing the scope of the present invention.

The present invention is illustrated below with reference to working examples, which do not in any way restrict the present invention, however.

### WORKING EXAMPLES

### Working Example 1

### Production of Inventive Matlike Foam Material Stock Having Adsorptive Properties, with Microporous Activated Carbon as Sorptive Particles

A reticulated open-pore (open-cell) polyurethane foam material having a thickness of approximately 20 mm, dimensions of 20 cm×20 cm, and a poriness (porosity) of approximately 12 to 14 ppi (average cell diameter or pore diameter of the foam material: approximately 2 mm), and also having a density of approximately 40 kg/m³, is squeezed off with an isocyanate-reactive polyurethane adhesive (squeeze-off effect: 100%) and is subsequently loaded with varying amounts of sorptive particles (example 1A: 30% by weight; example 1B: 40% by weight; example 1C: 55% by weight; example 1D: 70% by weight; example 1E: 80% by weight, all of the weight percentages being based on the material as a whole).

The odorant- and/or noxiant-adsorbing material used is a particulate activated carbon in the form of activated carbon spheres, as is available commercially from Blücher GmbH, Erkrath, and from Adsor-Tech, Premnitz, (product data of the microporous activated carbon spheres used: average activated carbon sphere diameter approximately 0.55 mm, BET surface area approximately 1580 m²/g, adsorption volume V_{ads} approximately 430 cm³/g, micropore volume fraction 60%, total pore volume by Gurvich method ≧0.70 cm³/g, specific micropore surface area fraction≧80%, micropore surface area by carbon black method approximately 1280 m³/g, average pore diameter≦20 Å, total porosity approximately 55%, bursting pressure per active sphere approximately 10 newtons, iodine number 1400 mg/g, and butane adsorption 35%).

For the reactive crosslinking of the adhesive, the whole is left to cure first at 100° C. for one hour and subsequently at room temperature in air for five hours, resulting in a cured foam material stock with the activated carbon particles fixed to its pore walls.

This produces inventive matlike foam material stock having adsorptive properties, loaded with different amounts of microporous activated carbon particles (examples 1A to 1E).

### Working Example 2

### Production of Inventive Matlike Foam Material Stock Having Adsorptive Properties, with Meso-/Macroporous Activated Carbon as Sorptive Particles

Working example 1 is repeated but, departing from working example 1, a different activated carbon was used which is significantly less microporous and more coarsely granular, i.e. possesses larger particle diameters (product data of the meso-/macroporous activated carbon spheres used: average activated carbon sphere diameter approximately 1.5 mm, BET surface area approximately 1500 m²/g, adsorption volume V_{ads} approximately 480 cm³/g, micropore volume fraction≦40%, specific micropore surface area fraction≦30%, average pore diameter ≧40 Å, total porosity approximately 50%, bursting pressure per active sphere approximately 1 newton, iodine number≦1000 mg/g, butane adsorption≦20%). The activated carbon used is again available commercially (e.g., from Kureha or from Rohm & Haas Company).

This equally produces inventive matlike foam material stock having adsorptive properties, which, in contrast to working example 1, are loaded with a more coarsely particulate activated carbon having a higher mesopore and macropore volume fraction and mesopore and macropore surface area fraction.

### Working Example 3

### Implementation of Different Physicochemical Measurements and Evaluation

On the inventive foam material stock as produced in the above-described working examples 1 and 2, various measurements in respect of adsorption efficiency and various physicochemical data are carried out, as summarized below in the table that follows.

It is apparent that, through the use of a fine-grained, microporous activated carbon in the aforementioned proportions (working example 1), it is possible to achieve a significantly increased adsorption efficiency in relation to the use of a coarsely particulate meso-/macroporous activated carbon. The results achieved with the more coarsely granular activated carbon particles, however, are still sufficient, although the adsorption performances obtained with the microporous activated carbon are significantly increased.

The working examples demonstrate that, through the selection of a microporous activated carbon and through the setting of the ratio of average pore diameter of the foam material to average particle diameter of the sorptive particles, it is possible to exert targeted control over the adsorption efficiency, more particularly the adsorption kinetics and the adsorption performance, and over the filtration efficiency. The examples also show that an optimum loading with regard to the sorptive particles is achieved in the range from 40% to 80% by weight.

| | TABLE | | | | | | | | | |
|---|---|---|---|---|---|---|---|---|---|---|
| | Example | | | | | | | | | |
| | 1A | 1B | 1C | 1D | 1E | 2A | 2B | 2C | 2D | 2E |
| Pressure drop | | | | | | | | | | |
| Pressure drop (ISO 11155-1) | <8 | <8 | <10 | <10 | <10 | <15 | <15 | <18 | <20 | <20 |
| at 0.35 m/s [Pa] | | | | | | | | | | |
| Pressure drop (ISO 11155-1) | <20 | <22 | <25 | <25 | <25 | <25 | <25 | <28 | <30 | <30 |
| at 0.7 m/s [Pa] | | | | | | | | | | |
| Pressure drop (ISO 11155-1) | <35 | <37 | <40 | <40 | <40 | <40 | <43 | <45 | <47 | <47 |
| at 1.0 m/s [Pa] | | | | | | | | | | |
| Pressure drop (ISO 11155-1) | <70 | <75 | <80 | <80 | <80 | <85 | <85 | <90 | <95 | <95 |
| at 1.5 m/s [Pa] | | | | | | | | | | |
| Toluene adsorption performance | | | | | | | | | | |
| (ISO 11155-2, 10 ppm toluene, | | | | | | | | | | |
| 23° C., 50% relative humidity) | | | | | | | | | | |
| Initial breakthrough at | <10 | <5 | <2 | <1 | <1 | <20 | <15 | <15 | <9 | <7 |
| 0.35 m/s [%] | | | | | | | | | | |
| Initial breakthrough at | <15 | <10 | <3 | <1 | <1 | <25 | <20 | <15 | <9 | <8 |
| 0.73 m/s [%] | | | | | | | | | | |
| Time to 10% breakthrough | >5 | >7 | >10 | >12 | >15 | >2 | >4 | >5 | >7 | >10 |
| [h] at 0.35 m/s | | | | | | | | | | |
| Time to 50% breakthrough | >12 | >15 | >18 | >20 | >20 | >5 | >7 | >8 | >10 | >15 |
| [h] at 0.35 m/s | | | | | | | | | | |
| Time to 10% breakthrough | >4 | >5 | >9 | >10 | >12 | >1 | >3 | >3 | >5 | >6 |
| [h] at 0.73 m/s | | | | | | | | | | |
| Time to 50% breakthrough | >10 | >12 | >15 | >17 | >17 | >3 | >5 | >6 | >10 | >12 |
| [h] at 0.73 m/s | | | | | | | | | | |
| Flammability (DIN 53438, | | | | | | | | | | |
| Parts 2 and 3) | | | | | | | | | | |
| Flammability, margin [class] | K1 | K1 | K1 | K1 | K1 | K1 | K1 | K1 | K1 | K1 |
| Flammability, remaining material | F1 | F1 | F1 | F1 | F1 | F1 | F1 | F1 | F1 | F1 |
| (surface) [class] | | | | | | | | | | |
| Ratio of average pore diameter | about | about | about | about | about | about | about | about | about | about |
| of foam material to average | 3.6 | 3.6 | 3.6 | 3.6 | 3.6 | 1.3 | 1.3 | 1.3 | 1.3 | 1.3 |
| particle diameter of activated | | | | | | | | | | |
| carbon | | | | | | | | | | |

1-15. (canceled)

16. A matlike foam material stock for purposes of air-purification and air-filtration, especially for installation into ceilings and ceiling systems, walls and wall systems, air-conditioning devices, ventilation shafts, as building material or the like,
where the foam material stock comprises an air-permeable matlike three-dimensional support, the support being formed as an open-cell or open-pore foam material;
where provided or taken up into the support is an odorant- and/or noxiant-sorbing material, the odorant- and/or noxiant-sorbing material being formed as an odorant- and/or noxiant-adsorbing sorbent based on discrete granular sorptive particles having an average particle diameter in the range from 0.01 to 2.0 mm in the form of activated carbon, the sorptive particles being fixed on the support and the activated carbon having a micropore volume fraction, formed of pores having pore diameters of ≦20 Å, of at least 60%; and
where the ratio of average pore diameter of the open-cell or open-pore foam material used as support to the average particle diameter of the sorptive particles is in the range from 1.5 to 7.

17. The foam material stock of claim 1, wherein the sorptive particles are fixed on the walls of the cells or pores of the foam material.

18. The foam material stock of claim 1, wherein the support is an open-pore or open-cell foam material based on at least one organic polymer.

19. The foam material stock of claim 4, wherein the polymer is selected from the group consisting of polyurethanes, polyolefins, polystyrenes, polyvinyl chlorides, polyisocyanurates and formaldehyde resins.

20. The foam material stock of claim 4, wherein the support is a polyurethane-based or polyolefin-based foam material.

21. The foam material stock of claim 1, wherein the support is an open-pore or open-cell foam material having an average pore diameter of 1 to 5 mm.

22. The foam material stock of claim 1, wherein the support is an open-pore or open-cell foam material having an average pore diameter of 1.5 to 3 mm.

23. The foam material stock of claim 1, wherein the support is stiffened or cured by thermal or chemical curing.

24. The foam material stock of claim 8, wherein the support has been impregnated with a chemical curing agent and subsequently cured, where the curing agent is an adhesive or another bonding composition which serves also to fix the sorptive particles.

25. The foam material stock of claim 1, wherein the sorptive particles are fixed to the support by means of a bonding composition or an adhesive.

26. The foam material stock of claim 1, wherein the odorant- and/or noxiant-sorbing material is of spherical shape where the average particle diameter is in the range from 0.05 to 1.0 mm.

27. The foam material stock of claim 1, wherein the ratio of the average pore diameter of the open-cell or open-pore foam material used as support to the average particle diameter of the sorptive particles is in the range from 1.5 to 6.

28. The foam material stock of claim 1, wherein the odorant- and/or noxiant-sorbing material is an activated carbon having a micropore volume fraction, formed of pores having pore diameters of ≦20 Å, of at least 65%, based on the total pore volume.

29. The foam material stock of claim 1, wherein the odorant- and/or noxiant-sorbing material is an activated carbon having a micropore volume formed of pores having pore diameters of ≦20 Å, measured according to the carbon black method, of at least 0.40 cm³/g.

30. The foam material stock of claim 1, wherein the odorant- and/or noxiant-sorbing material is an activated carbon having a specific micropore surface fraction, formed of pores having pore diameters of ≦20 Å, of at least 70%, based on the specific total surface area (BET) of the activated carbon.

31. The foam material stock of claim 1, wherein the odorant- and/or noxiant-adsorbing material is an activated carbon having a micropore surface area formed of pores having pore diameters of ≦20 Å, measured according to the carbon black method, of at least 400 m²/g.

32. The foam material stock of claim 1, wherein the odorant- and/or noxiant-sorbing material is an activated carbon having an average pore diameter (mean average pore diameter) of not more than 30 Å.

33. The foam material stock of claim 1, wherein the odorant- and/or noxiant-sorbing material is an activated carbon which has an impregnation, where the impregnation is selected from the group consisting of (i) metals; (ii) enzymes; (iii) basic compounds; (iv) acidic compounds; and mixtures as well as combinations thereof and where the impregnation, based on the activated carbon, is applied in an amount of 0.01% to 30% by weight.

34. A process of eliminating emissions of noxiants or odorants by means of adsorption, the process comprising using a matlike foam material stock of claim 1.

35. The process of claim 19, wherein the process is applied for eliminating emissions of noxiants or odorants in enclosed spaces, buildings, vehicles, aircraft or the like.

36. The process of claim 19, wherein the matlike foam material stock is installed in ceilings and ceiling systems, walls and wall systems, air-conditioning devices, ventilation shafts, as a building material or the like.
